(19) United States
(12) Patent Application Publication
(10) Pub. No.: US 2014/0167598 A1
(43) Pub. Date: Jun. 19, 2014

(54) LIGHT EMITTING DEVICE

(71) Applicant: GENIUS ELECTRONIC OPTICAL CO., LTD., Taichung City (TW)

(72) Inventors: Feng-Kuan CHEN, Taichung City (TW); Yi- Jie HUANG, Taichung City (TW); Lu- An CHEN, Taichung City (TW)

(73) Assignee: GENIUS ELECTRONIC OPTICAL CO., LTD., Taichung City (TW)

(21) Appl. No.: 13/795,755

(22) Filed: Mar. 12, 2013

(30) Foreign Application Priority Data
Dec. 18, 2012 (TW) 101148088

(51) Int. Cl. H05B 33/12

(52) U.S. Cl. CPC H05B 33/12
USPC 313/498

(57) ABSTRACT

Provided is a light emitting device including: a substrate; a light emitting diode chip; and a phosphor layer. The phosphor layer includes a first cover part and a second cover part; the first cover part is disposed on the top surface of the light emitting diode chip, and the second cover part covers the surface of the substrate at the peripheral area of the light emitting diode chip. Further, there is a height difference between the top surface of the second cover part and the top surface of the first cover part; the top surface of the second cover part is at a position lower than that of the top surface of the first cover part.

### CROSS-REFERENCE TO RELATED APPLICATION

This application claims priority to Taiwan Application No. 101148088, filed on Dec. 18, 2012, the contents of which are hereby incorporated by reference in their entirety for all purposes.

### BACKGROUND

1. Field of the Invention

The present invention relates to a light emitting device, and more particularly to a light emitting device capable of improving the light emitting efficiency of the light emitting device and preventing yellow-ring phenomenon and color deviation by modifying the structure of phosphor layer on the light emitting diode chip.

2. Brief Description of the Related Art

Light emitting diode (LED) is advantageous in that it has low power consumption, long service life, fast speed of response, and small size. Currently, white-light LED illumination industry is continuously flourishing, and has great potential in areas of backlight source of mobile panel and automobile industry.

Now, there are mainly two kinds of white-light light emitting devices on the market. One kind uses phosphor to convert blue light generated by blue LED and UV light generated by UV LED into white light with dichromatic or trichromatic, respectively. This is called “Phosphor Converted-LED”. The other kind is multichip LED, generating white light by using the combination of two or more LEDs with different colors. Blue LED with yellow phosphor are the most common choice, mainly employed in various LED illumination devices such as light bulb, mobile panel, vehicle lighting, street light, and flashlight.

As for the most commonly used white-light light emitting device (with blue LED adding a yellow phosphor layer), the method of yellow phosphor coating has great influence on light distribution and uniformity of color temperature, and may cause undesirable effect on spectrum and color rendering property.

As shown in FIG. 1, according to a conventional phosphor coating method, phosphor gel is directly dispensed on a substrate 10 and a LED chip 20 to form a phosphor layer 30. However, since the phosphor layer 30 is formed of a gel material, it may flow and therefore most of the phosphor layer 30 is concentrated at the edge of the LED chip 20, thickness of the phosphor layer 30 of the top surface of the LED chip 20 is thinner than that of the side surface of the LED chip 20. For instance, in an example of a light emitting device employing blue LED adding a yellow phosphor layer, according to the foregoing structure, more yellow light is generated at the side surface and less yellow light is generated at the central area. Hence, yellow-ring phenomenon and color deviation may occur, causing visual discomfort.

Please refer to Table 1:

| Angle | correlated color temperature (CCT) |
|---|---|
| −90 | 4913 K |
| 0 | 6497 K |
| 90 | 4375 K |

As shown in Table 1, which is an example of a light emitting device employing blue LED adding a yellow phosphor layer, correlated color temperature (CCT) is 6497K at the central area (that is, angle=0) of the light emitting device, and the average CCT is 4644K at the peripheral area (that is, angle=±90) of the light emitting device (yellowish). The CCT difference between the central area and the peripheral area is 1853K. The larger the CCT difference is, the stronger the yellow-ring phenomenon and color deviation phenomenon are.

Please further refer to FIG. 2, which illustrates another kind of conventional light emitting device; wherein, the LED chip 20 is placed at the bottom of a reflector 40, and then a dispensing method is employed to coat the phosphor gel onto the LED chip 20, thereby forming phosphor layer 30 within a limited area inside the reflector 40. However, due to flowing, deposition and surface tension phenomenon, center of the phosphor layer 30 may have a convex shape, and peripheral area (adjacent to the inner side of the reflector 40) of the phosphor layer 30 may be concave-shaped. This results in uneven thickness of the phosphor layer 30 on the LED chip 20, thereby causing non-uniform color temperature and yellow-ring phenomenon while emitting light.

### SUMMARY

Hence, in order to overcome the deficiencies of the prior art, an objective of the present invention is to provide a light emitting device, which modifies the structure of phosphor layer on light emitting diode chip to reduce the correlated color temperature difference between central area and peripheral area of the light emitting device, thereby preventing yellow-ring phenomenon and color deviation, and thus allows the light emitting diode chip to perform superior light emitting efficiency, excellent color rendering property, and uniform illumination.

With the above objective in mind, the present invention provides a light emitting device including: a substrate; a light emitting diode chip disposed on the substrate; and a phosphor layer covering the light emitting diode chip. The phosphor layer includes a first cover part and a second cover part, wherein the first cover part covers the top surface of the light emitting diode chip, and the second cover part is located on the surface of the substrate at the peripheral area of the light emitting diode chip. Further, there is a height difference between the top surface of the second cover part and the top surface of the first cover part, wherein the top surface of the second cover part is at a position lower than that of the top surface of the first cover part.

Wherein, the top surface of the first cover part of the phosphor layer is a flat surface, and the top surface of the second cover part of the phosphor layer is a flat surface.

Wherein, the thickness between the top surface of the first cover part and the top surface of the light emitting diode chip is a first thickness, and the thickness between the top surface of the second cover part and the top surface of the substrate is a second thickness; wherein the first thickness is essentially equal to the second thickness.

As set forth above, the present invention is advantageous in that, by modifying the structure of phosphor layer on light emitting diode chip, the correlated color temperature difference between central area and peripheral area of the light emitting device is reduced, thereby preventing yellow-ring phenomenon and color deviation, and thus allows the light emitting device to perform better light emitting quality and uniform illumination.

### BRIEF DESCRIPTION OF THE DRAWINGS

FIG. 1 is a first view illustrating a light emitting device according to prior art;

FIG. 2 is a second view illustrating the light emitting device according to the other prior art;

FIG. 3 illustrates a light emitting device according to a preferred embodiment of the present invention;

FIG. 4 is a sectional view illustrating manufacture of the preferred embodiment of the present invention in practice;

FIG. 5 is a sectional view illustrating manufacture of the preferred embodiment of the present invention in practice;

FIG. 6 is a sectional view illustrating manufacturing process of a plurality of light emitting diode chips in practice;

FIG. 7 is a sectional view illustrating manufacturing process of the plurality of light emitting diode chips in practice; and

FIG. 8 is a sectional view illustrating manufacturing process of the plurality of light emitting diode chips in practice.

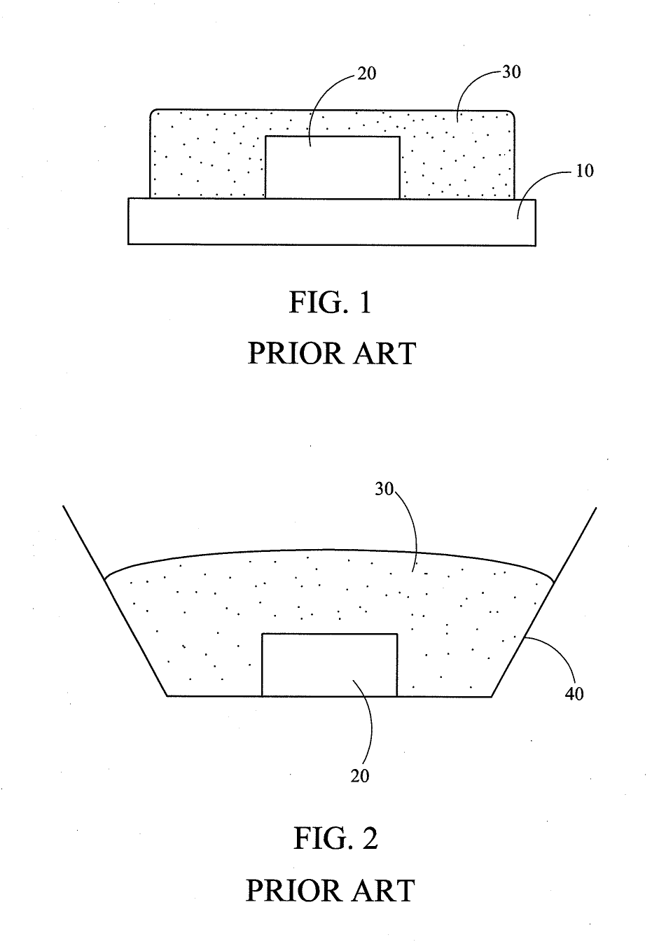

### DETAILED DESCRIPTION

Hereinafter, the preferred embodiment of the present invention will be described in detail with reference to the accompanying drawings, to describe the structure and features of the present invention. It will be understood that the following description is not intended to limit the invention to the form disclosed herein.

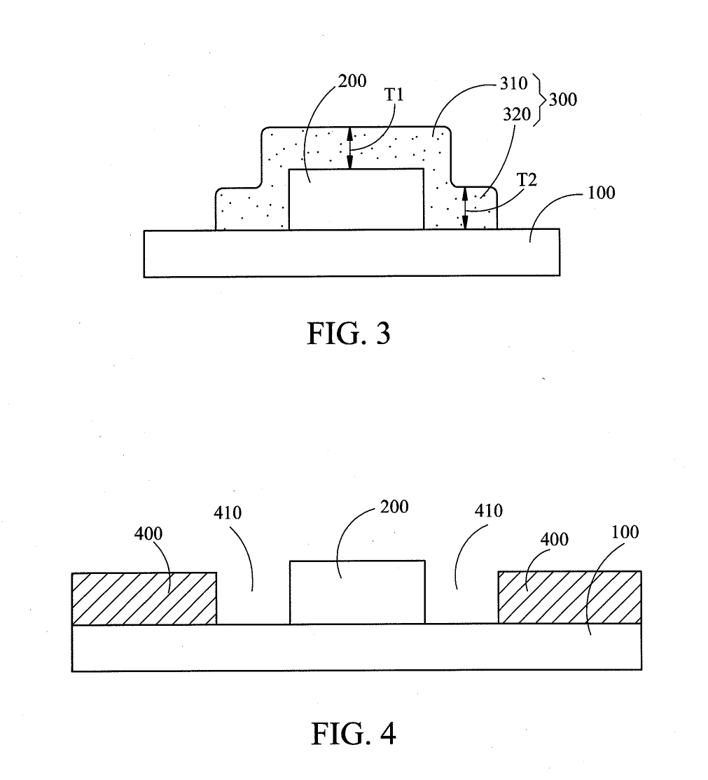

Please refer to FIG. 3, which illustrates a light emitting device according to the present invention. The present invention provides a light emitting device. The light emitting device is a flat plate type light emitting device, and includes: a substrate 100; a light emitting diode chip 200 disposed on the substrate 100; and a phosphor layer 300 covering the light emitting diode chip 200. The phosphor layer 300 includes a first cover part 310 and a second cover part 320, wherein the first cover part 310 covers the top surface of the light emitting diode chip 200, and the second cover part 320 is located on the surface of the substrate 100 at the peripheral area of the light emitting diode chip 200. Further, there is a height difference between the top surface of the second cover part 320 and the top surface of the first cover part 310, wherein the top surface of the second cover part 320 is at a position lower than that of the top surface of the first cover part 310.

Wherein, the top surface of the first cover part 310 of the phosphor layer 300 is a flat surface, and the top surface of the second cover part 320 of the phosphor layer 300 is a flat surface. The thickness between the top surface of the first cover part 310 and the top surface of the light emitting diode chip 200 is a first thickness T1, and the thickness between the top surface of the second cover part 320 and the top surface of the substrate 100 is a second thickness T2, the first thickness T1 is essentially equal to the second thickness T2.

By using the foregoing structure of the phosphor layer 300, the thickness of the phosphor layer 300 at the top surface and the side surface of the light emitting diode chip 200 may be controlled. Take a light emitting device employing blue LED adding a yellow phosphor layer for example, by using the structure according to the present invention, color rendering property at the top surface and the side surface of the light emitting diode chip 200 is more uniform, the correlated color temperature difference between central area and peripheral area of the light emitting device is reduced, the yellow-ring phenomenon and color deviation is prevented, thereby allowing a better light emitting quality.

Please refer to Table 2:

| Angle | correlated color temperature (CCT) |
|---|---|
| −90 | 6174 K |
| 0 | 6761 K |
| 90 | 6466 K |

As shown in Table 2, which is an example of a light emitting device employing blue LED adding a yellow phosphor layer, correlated color temperature (CCT) is 6761K at the central area (that is, angle=0) of the light emitting device, and the average CCT is 6320K at the peripheral area (that is, angle=±90) of the light emitting device (yellowish). The CCT difference between the central area and the peripheral area is 441K. Comparing to that of the light emitting device with conventional phosphor layer structure, the CCT difference according to the present invention is relatively smaller, therefore the color deviation phenomenon is reduced and uniform light emission may be performed.

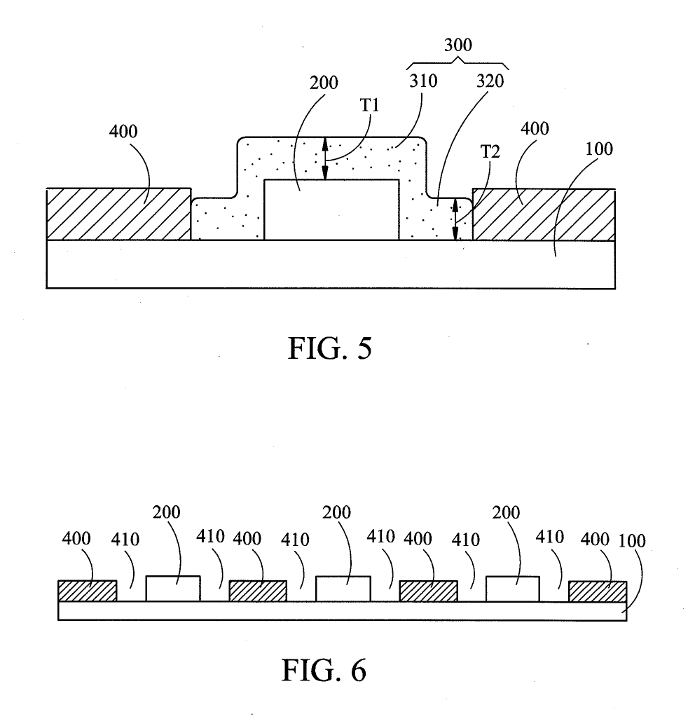

Please refer to FIGS. 4 and 5 for the preferred actual manufacturing method according to the present invention. The light emitting diode chip 200 is attached to the substrate 100 using flip-chip method, and then a mask 400 with an opening 410 is disposed on the substrate 100. Since the flip-chip method requires no wire bonding and has a large contact area with the substrate, it has advantages of fast speed of manufacturing, excellent heat dissipation property, small size, and large light emitting area. The conventional chip on board (COB) method is to firstly dispose the light emitting diode chip 200 onto the substrate 100, and then uses wire bonding to bond the light emitting diode chip 200 to substrate 100. This process requires a longer manufacturing time, however, the present invention may also employ the COB method to dispose the light emitting diode chip 200 on the substrate 100.

Further, expose the light emitting diode chip 200 by using the opening 410 of the mask 400, as shown in FIG. 4, and then spray phosphor gel (not shown in the figures) onto the light emitting diode chip 200 and partially the substrate 100 to form the phosphor layer 300. In practice, the opening 410 of the mask 400 defines the region where the phosphor layer 300 is, and the size of the opening 410 is the size of the region. The opening 410 may have a circular shape, a square shape, or any other shapes according to various usage requirements.

To form the phosphor layer 300, the spray-coating process may be performed one or several times to achieve the desired thickness, allowing the light emitting device to achieve desired correlated color temperature. When the spray-coating process is performed several times, the position of the mask 400 needs to be matched with the position of the substrate 100 during each spray-coating process. The abovementioned method prevents the phosphor layer 300 from having uneven thickness caused by location shifting of the mask 400 during each spray-coating process. Since the top surface of the first cover part 310 of the phosphor layer 300 is a flat surface, the top surface of the second cover part 320 of the phosphor layer 300 is a flat surface, as shown in FIG. 5, and the material of the phosphor layer 300 (that is, phosphor gel) is spray-coated on the substrate 100 uniformly, the first thickness T1 equals to the second thickness T2. After the phosphor layer 300 is completed, the mask 400 is removed.

It is worth mentioning that, in practice, the second thickness T2 should be thinner than the thickness of the mask 400 in order to allow the mask 400 to be removed from the substrate 100 easily. Further, if the thickness of the mask 400 is larger than the thickness of the light emitting diode chip 200, it will be difficult to attach the material of the phosphor layer 300 (that is, phosphor gel) to the side surface of the light emitting diode chip 200. Hence, in practice, the thickness of the mask 400 should be thinner than the thickness of the light emitting diode chip 200.

In practice, after forming the foregoing light emitting device, a potting method or a lens method may be further performed on the substrate 100 to cover and protect the light emitting diode chip 200 and the phosphor layer 300.

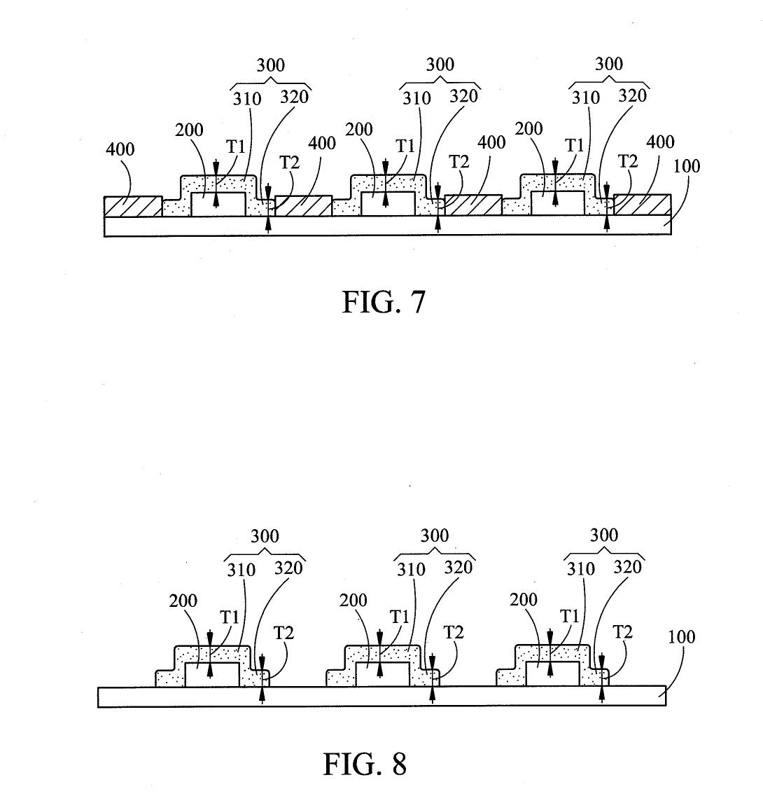

Please further refer to FIGS. 6 to 8, which illustrate manufacturing process of a plurality of light emitting diode chips in practice. The substrate 100 has a plurality of light emitting diode chips 200 formed thereon. The process of spray-coating phosphor gel to form the phosphor layer 300 requires performing spray-coating several times to obtain the desired thickness for the phosphor layer 300, thereby allowing every light emitting device to achieve the desired correlated color temperature. Further, during each spray-coating process, the position of the mask 400 and the position of the substrate 100 must be fixed. The abovementioned method prevents the formed phosphor layer 300 from having uneven thickness caused by location shifting of the mask 400 during each spray-coating process. After the phosphor layer 300 is completed, the mask 400 is removed.

The previous description of the preferred embodiment is provided to further describe the present invention, not intended to limit the present invention. Any modification apparent to those skilled in the art according to the disclosure within the scope will be construed as being included in the present invention.

1. A light emitting device, comprising:
a substrate;
a light emitting diode chip disposed on the substrate; and
a phosphor gel layer, covering the light emitting diode chip, and comprising:
a first cover part and a second cover part, wherein the first cover part covers a top surface of the light emitting diode chip, and the second cover part is located on a surface of the substrate at peripheral area of the light emitting diode chip; there is a height difference between a top surface of the second cover part and a top surface of the first cover part, wherein the top surface of the second cover part is at a position lower than that of the top surface of the first cover part.

2. The light emitting device of claim 1, wherein the top surface of the first cover part of the phosphor gel layer is a flat surface.

3. The light emitting device of claim 1, wherein the top surface of the second cover part of the phosphor gel layer is a flat surface.

4. The light emitting device of claim 1, wherein a thickness between the top surface of the first cover part and the top surface of the light emitting diode chip is a first thickness, and a thickness between the top surface of the second cover part and the top surface of the substrate is a second thickness, and the first thickness is essentially equal to the second thickness.

5. A light emitting device, comprising:
a substrate;
a plurality of light emitting diode chips disposed on the substrate; and
a plurality of phosphor gel layers, covering the light emitting diode chips, and comprising:
a first cover part and a second cover part, wherein the first cover part covers a top surface of the light emitting diode chips, and the second cover part is located on a surface of the substrate at peripheral area of the light emitting diode chips; there is a height difference between a top surface of the second cover part and a top surface of the first cover part, wherein the top surface of the second cover part is at a position lower than that of the top surface of the first cover part,
wherein there is a space between the adjacent phosphor gel layers.
